(19) United States
(12) Patent Application Publication
(10) Pub. No.: US 2009/0230360 A1
(43) Pub. Date: Sep. 17, 2009

(54) Latent Curing Agent

(75) Inventors: Katsuhiko Komuro, Tochigi (JP); Masahiko Ito, Tochigi (JP); Tadasu Kawashima, Tochigi (JP); Daisuke Masuko, Tochigi (JP)

Correspondence Address: OLIFF & BERRIDGE, PLC, P.O. BOX 320850, ALEXANDRIA, VA, 22320-4850, US

(73) Assignee: SONY CHEMICAL & INFORMATION DEVICE CORPORATION, Tokyo (JP)

(21) Appl. No.: 12/227,905

(22) PCT Filed: Jan. 17, 2008
(86) PCT No.: PCT/JP2008/050484

§ 371 Date: Dec. 2, 2008

(30) Foreign Application Priority Data
Jan. 24, 2007 (JP) 2007-014252

(51) Int. Cl. H01B 1/12; C08L 63/00; C08L 23/18

(52) U.S. Cl. 252/500; 525/523; 525/342

(57) ABSTRACT

An aluminum chelate-based latent curing agent, which can cure a thermosetting epoxy resin at a relatively low temperature in a short time, is made latent by reacting a silsesquioxane-type oxetane derivative with an aluminum chelating agent in the presence of an alicyclic epoxy compound, and then further reacting the resultant mixture with a liquid epoxy resin and an imidazole compound or with an aromatic vinyl compound and a radical polymerization initiator.

### TECHNICAL FIELD

The present invention relates to an aluminum chelate-based latent curing agent which can initiate the curing of a thermosetting composition at a relatively low temperature, a production method thereof, and a thermosetting composition containing the aluminum chelate-based latent curing agent which has good storage stability.

### BACKGROUND ART

Thermosetting resin compositions, such as epoxy resins, are widely used for adhesion materials, molding materials and the like. One example of a curing agent used for such a thermosetting resin composition is a latent imidazole-based curing agent. Since this latent imidazole-based curing agent does not exhibit a curing performance in a normal storage state, it is widely used to turn thermosetting epoxy resin compositions into a one-pack curing composition having good handleability and good storage stability. Representative examples of such a latent imidazole curing agent include microcapsule-type agents which have an epoxy resin cured matter coating the surface of imidazole compound particles which are capable of curing the epoxy resin.

However, such a microcapsule-type latent imidazole curing agent gives a coat which is both mechanically and thermally relatively stable. Thus, to initiate the curing reaction, it is necessary to heat to 180° C. or more under pressure. Therefore, there has been the problem that such a microcapsule-type latent imidazole curing agent can not be applied to the low-temperature curing type epoxy resin compositions of recent years.

Accordingly, latent curing agents have been proposed which exhibit low-temperature and rapid curability even without the use of a toxic promoter, such as antimony and the like. For example, Patent Document 1 describes a microcapsule-type aluminum chelate-based latent curing agent having a polyvinyl alcohol coating layer formed on the surface of aluminum chelating agent particles (mother particles) which can generate a protonic acid in conjunction with a co-catalyst silanol (silane coupling agent etc.) to cause a cyclic ether (epoxy compound or oxetane compound) to undergo cationic ring-opening polymerization. In Patent Document 1, the polyvinyl alcohol coating layer is formed on the surface of the mother particles by a hybridization method in which polyvinyl alcohol fine particles (daughter particles) having a hydroxyl group, which reacts with the aluminum chelating agent, fuse and stick to the surface of the mother particles. Furthermore, Patent Document 2 describes a microcapsule-type aluminum chelate-based latent curing agent having a coating layer formed on the surface of mother particles. In Patent Document 2, fluorine resin fine particles (daughter particles) which do not have a functional group that can react with the aluminum chelating agent are made to stick to the surface of the mother particles by static electricity, and then the fluorine resin fine particles are fused by a hybridization method to form an integrated surface.

It is noted that details of the curing step for an aluminum chelate-based latent curing agent are described in paragraphs 0007 to 0010 of Patent Document 1.

[Patent Document 1] Japanese Patent Application Laid-Open No. 2002-368047

[Patent Document 2] Japanese Patent Application Laid-Open No. 2002-363255

### DISCLOSURE OF THE INVENTION

### Problems to be Solved by the Invention

However, in the case of aluminum chelate-based latent curing agents formed into a microcapsule by utilizing a hybridization method as described in Patent Documents 1 and 2, the microcapsule wall is formed by making the daughter particles collide into the mother particles so as to fuse, or making the daughter particles, which are stuck by static electricity, fuse due to the friction between them. As a result, irregularity and unevenness tend to occur on the surface, so that there is the problem that stable curing properties cannot be obtained. In addition, it is difficult to control the curing conditions. Furthermore, because the polymerization initiation temperature with respect to the DSC (differential thermal analysis) exothermic peak of a thermosetting epoxy resin composition blended with such a curing agent is too low, latency is in sufficient. Moreover, since an organic solvent (for example, toluene, ethyl acetate, MEK and PGMAC) is used during the preparation of a thermosetting composition in which such an aluminum chelate-based latent curing agent is used, the aluminum chelate-based latent curing agent needs to exhibit good solvent resistance.

It is an object of the present invention to solve the problems associated with the above-described conventional techniques, and to provide an aluminum chelate-based latent curing agent which can cure a thermosetting compound at a relatively low temperature in a short time by cationic-polymerization, and which has excellent solvent resistance. It is also an object of the present invention to provide a method for producing an aluminum chelate-based latent curing agent in which the curing conditions can be relatively easily controlled, and to provide a thermosetting composition containing the aluminum chelate-based latent curing agent.

### Means for Solving the Problems

The present inventors discovered that a substance obtained as a sediment by heating an aluminum chelating agent and a silsesquioxane-type oxetane derivative in the presence of an alicyclic epoxy compound in a non-aqueous solvent, and then further reacting the resultant mixture with a liquid epoxy resin and an imidazole compound or with an aromatic vinyl compound and a radical polymerization initiator, could fulfill the above-described objectives, thereby completing the present invention.

Specifically, the present invention provides an aluminum chelate-based latent curing agent being made latent by reacting a silsesquioxane-type oxetane derivative with an aluminum chelating agent in the presence of an alicyclic epoxy compound, and then further reacting the resultant mixture with a liquid epoxy resin and an imidazole compound or with an aromatic vinyl compound and a radical polymerization initiator.

Furthermore, the present invention provides a method for producing the above-described aluminum chelate-based latent curing agent, the aluminum chelate-based latent curing agent being obtained as a sediment by reacting an aluminum chelating agent and a silsesquioxane-type oxetane derivative in the presence of an alicyclic epoxy compound in a non-aqueous solvent by heating, and then further reacting the resultant mixture with a liquid epoxy resin and an imidazole compound or with an aromatic vinyl compound and a radical polymerization initiator.

Furthermore, the present invention provides a thermosetting composition containing the above-described aluminum chelate-based latent curing agent, a silane coupling agent and a thermosetting compound. Still further, the present invention provides an anisotropic conductive composition in which anisotropic conductive particles are dispersed in this thermosetting composition.

### ADVANTAGES OF THE INVENTION

The aluminum chelate-based curing agent according to the present invention is made latent by reacting a silsesquioxane-type oxetane derivative with an aluminum chelating agent in the presence of an alicyclic epoxy compound. The latency is thought to be achieved according to the reasons described in the following. Specifically, because the oxetane ring of a silsesquioxane-type oxetane derivative has excellent cationic polymerizability as a result of an ether oxygen thereof having a higher nucleophilicity than an oxirane ring, the oxetane ring undergoes ring-opening polymerization due to the action of the aluminum chelating agent. Furthermore, silanol groups may be formed as a result of some of the alkoxysilyl groups of the polymer being hydrolyzed by the slight amount of moisture in the polymerization system. Alternatively, in some cases the silanol groups may have been present from the start in the silsesquioxane-type oxetane derivative. These silanol groups interact with the aluminum chelating agent, whereby the aluminum chelating agent is chelated with the polymerized matter. At this stage, along with the ring-opening polymerization of the oxetane ring, epoxy groups in the alicyclic epoxy compound undergo ring-opening polymerization, and are integrated into the polymerized matter along with the aluminum chelating agent. Next, by additionally reacting with a liquid epoxy resin and an imidazole compound, or reacting with an aromatic vinyl compound and a radical polymerization initiator, the resultant polymers form a microcapsule wall around the polymerized matter. As a result, a non-aqueous type aluminum chelate-based curing agent is made to be latent. Therefore, not only can an aluminum chelating agent which is liquid at ordinary temperatures be used as a latent curing agent, but good solvent resistance is also exhibited.

If such a non-aqueous type aluminum chelate-based latent curing agent dissolves the microcapsule wall, it can cure a thermosetting compound, such as an epoxy resin or an oxetane compound, at a relatively low temperature in a short time. Furthermore, because this aluminum chelate-based latent curing agent can be produced in a non-aqueous solvent, deactivation can be avoided, whereby deterioration in the curing properties can be suppressed.

### BEST MODE FOR CARRYING OUT THE INVENTION

The aluminum chelate-based latent curing agent according to the present invention is made latent by reacting a silsesquioxane-type oxetane derivative with an aluminum chelating agent in the presence of an alicyclic epoxy compound, and then further reacting the resultant mixture with a liquid epoxy resin and an imidazole compound or with an aromatic vinyl compound and a radical polymerization initiator. Because an aluminum chelating agent which can realize low-temperature, rapid curing is used for this latent curing agent, good low-temperature, rapid curability can be conferred to a thermosetting composition blended with this latent curing agent. Furthermore, because it is thought that the aluminum chelating agent is coated by a polymer, even when this aluminum chelate-based latent curing agent is blended in a thermosetting composition and made into a one-pack agent, the storage stability of the thermosetting composition can be greatly improved.

The aluminum chelate-based latent curing agent according to the present invention is a microcapsule having a structure in which a polymer shell obtained by reacting a liquid epoxy resin and an imidazole compound or a polymer shell obtained by reacting an aromatic vinyl compound and a radical polymerization initiator is coated around a core which is a complex of a polymer of a silsesquioxane-type oxetane derivative, an aluminum chelating agent, and an alicyclic epoxy compound. If this microcapsule agglomerates, the structure may have a plurality of cores scattered in a polymer matrix of the alicyclic epoxy compound. In this instance, as the polymer of the silsesquioxane-type oxetane derivative, polymers having various degrees of polymerization may be obtained, such as dimers, oligomers or even higher polymers, according to the charged amount of aluminum chelating agent and silsesquioxane-type oxetane derivative, the reaction temperature conditions and the like. However, from the standpoint of particle size control, an oligomer having a degree of polymerization of 10 to 100 is preferable.

The aluminum chelate-based latent curing agent according to the present invention preferably has a spherical shape, and from the standpoint of curing properties and dispersibility, preferably has a particle size of 1 to 10 μm, and more preferably 2 to 3 μm.

Furthermore, if the used amount of the silsesquioxane-type oxetane derivative with respect to the aluminum chelating agent in the aluminum chelate-based latent curing agent according to the present invention is too small, the encapsulation reaction is slowed. If the used amount is too large, the curing agent solidifies. Thus, with respect to 100 parts by weight of the aluminum chelating agent, the used amount is preferably in the range of from 0.1 to 500 parts by weight, more preferably in the range of from 1 to 500 parts by weight and especially preferably in the range of from 10 to 500 parts by weight. Furthermore, if the used amount of the alicyclic epoxy compound with respect to the sum of the aluminum chelating agent and the silsesquioxane-type oxetane derivative is too small, the curing agent does not turn into a powder. If the used amount is too large, the curing properties deteriorate. Thus, with respect to 100 parts by weight of the sum of the aluminum chelating agent and the silsesquioxane-type oxetane derivative, the used amount is preferably in the range of from 0.1 to 1,000 parts by weight, more preferably in the range of from 0.5 to 500 parts by weight and especially preferably in the range of from 1 to 500 parts by weight.

Examples of the aluminum chelating agent in the aluminum chelate-based latent curing agent according to the present invention include complex compounds having three β-ketoenolate negative ions coordinated to aluminum, as represented by formula (4).

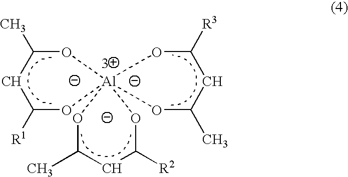

Here, R¹, R² and R³ each independently represent an alkyl group or an alkoxyl group. Examples of the alkyl group include a methyl group, an ethyl group and the like. Examples of the alkoxyl group include a methoxy group, an ethoxy group, an oleyloxy group and the like.

Specific examples of the aluminum chelating agent represented by formula (4) include aluminum ethylacetoacetate diisopropylate (ALCH, Kawaken Fine Chemicals Co., Ltd.), aluminum trisethylacetoacetate (ALCH-TR, Kawaken Fine Chemicals Co., Ltd.), aluminum alkylacetoacetate diisopropylate (Aluminum Chelate M, Kawaken Fine Chemicals Co., Ltd.), aluminum bisethylacetoacetate monoacetylacetonate (Aluminum Chelate D, Kawaken Fine Chemicals Co., Ltd.) or aluminum trisacetylacetonate (Aluminum Chelate A(W), Kawaken Fine Chemicals Co., Ltd.).

Examples of the silsesquioxane-type oxetane derivative in the aluminum chelate-based latent curing agent according to the present invention include substances preferably containing 95% or more of the compound represented by formula (1) (OX-SQ-H, Toagosei Co., Ltd.), whose silsesquioxane skeleton has an oxetane ring and which is substituted with at least one oxetanyl group. The compound represented by the formula (1), usually, is a pale yellow viscous liquid which has a number average molecular weight of 1,000 to 2,000. This compound dissolves in general-purpose organic solvents, and can easily mix even in epoxy resins and oxetanes. Furthermore, to the extent that the effect of the present invention is not harmed, other oxetane derivatives (for example, a biphenyl-type oxetane derivative; OXBP, Ube Industries, Ltd.) may also be used together with the silsesquioxane-type oxetane derivative.

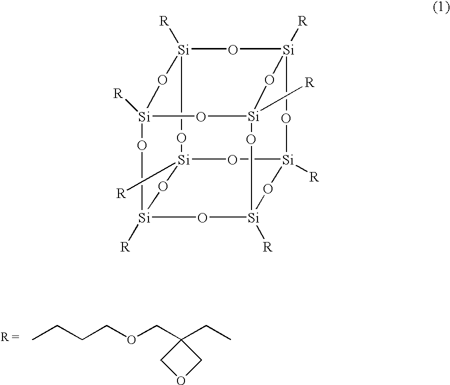

The silsesquioxane-type oxetane derivative represented by formula (1) can be easily produced by condensating the alkoxysilyl group of the oxetanyl silane compound represented by the formula (2) (OXT-610, Toagosei Co., Ltd.: boiling point of 125 to 128° C. at 1 mmHg, viscosity of 7 to 8 mPa·s (25° C.)) in the presence of an alkali or an acid in water. As will be described below, this compound represented by the formula (2) can also be used as a silane coupling agent.

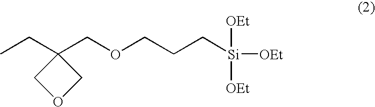

The alicyclic epoxy compound used in forming the aluminum chelate-based latent curing agent according to the present invention preferably has two or more epoxy groups in one molecule. Examples of such an alicyclic epoxy compound include 3′,4′-epoxycyclohexylmethyl 3,4-epoxycyclohexanecarboxylate (CEL2021P, Daicel Chemical Industries Ltd.), 1,2,8,7-diepoxylimonene and the like. Among these, 3′,4′-epoxycyclohexylmethyl 3,4-epoxycyclohexanecarboxylate (CEL2021P, Daicel Chemical Industries Ltd.) is preferable from the standpoints of reactivity and the ease with which the product can be obtained.

The liquid epoxy resin used by the aluminum chelate-based latent curing agent according to the present invention preferably has two or more epoxy groups in one molecule in order to improve the physical properties of the microcapsule wall and the solvent resistance of the curing agent. Furthermore, from a usage standpoint, this liquid epoxy resin is preferably a thermosetting epoxy resin which is liquid at least at 0 to 50° C. Examples of such a liquid epoxy resin include bisphenol A-type epoxy resins (for example, YL980, Japan Epoxy Resins Co., Ltd.), bisphenol F-type epoxy resins, phenol novolac-type epoxy resins, naphthalene type epoxy resins and the like.

Examples of the imidazole compound, which is the curing agent for the liquid epoxy resin, include 2-ethyl-4(5)-methylimidazole, 1-benzyl-2-methylimidazole, 1-isobutyl-2-methylimidazole, 2-methylimidazole, 2-undecylimidazole, 2-heptadecylimidazole and the like.

If the used amount of the liquid epoxy resin is too small, the latent properties and the solvent resistance of the curing agent both deteriorate, while if the used amount is too large, the reactivity of the curing agent deteriorates. Thus, with respect to 1 part by weight of the aluminum chelating agent, the used amount is preferably in the range of from 0.1 to 200 parts by weight, and more preferably in the range of from 0.1 to 100 parts by weight. Furthermore, if the used amount of the imidazole compound is too small, the curing reaction is suppressed, while if the used amount is too large, the degree of polymerization of the epoxy resin decreases. Thus, with respect to 1 part by weight of the liquid epoxy resin, the used amount is preferably in the range of from 0.01 to 1 part by weight.

The aromatic vinyl compound used by the aluminum chelate-based latent curing agent according to the present invention preferably uses in combination a monofunctional aromatic vinyl compound and a polyfunctional aromatic vinyl compound in order to improve the physical properties of the microcapsule wall etc., and the solvent resistance of the curing agent. Examples of the monofunctional aromatic vinyl compound include styrene, α-methylstyrene, 3-methylstyrene and the like. Examples of the polyfunctional aromatic vinyl compound include divinylbenzene, trivinylbenzene and the like.

As the radical polymerization initiator for the aromatic vinyl compound, a well-known radical polymerization initiator may be appropriately used. Examples thereof include aliphatic acyl peroxides, such as dilauroyl peroxide, and aromatic acyl peroxides, such as dibenzoyl peroxide.

If the used amount of the aromatic vinyl compound is too small, the physical properties of the microcapsule wall and the solvent resistance of the curing agent are insufficient, while if the used amount is too large, some of the aromatic vinyl compound is not cured and remains in the reaction system. Thus, with respect to 1 part by weight of the aluminum chelating agent, the used amount is preferably in the range of from 0.1 to 200 parts by weight, and more preferably in the range of from 0.1 to 100 parts by weight. Among that amount, in consideration of suitable shell strength, the blended proportion between the monofunctional aromatic vinyl compound and the polyfunctional aromatic vinyl compound is preferably such that, with respect to 1 part by weight of the monofunctional aromatic vinyl compound, the polyfunctional aromatic vinyl compound is in the range of from 0.01 to 1 part by weight, and more preferably in the range of from 0.01 to 0.5 parts by weight. Furthermore, if the used amount of the radical polymerization initiator is too small, some of the aromatic vinyl compound is not cured, while if the used amount is too large, problems arise with safety during production. Thus, with respect to 1 part by weight of the aromatic vinyl compound, the used amount is preferably in the range of from 0.01 to 2 parts by weight, and more preferably in the range of from 0.01 to 1 part by weight.

The aluminum chelate-based latent curing agent according to the present invention can be obtained as a sediment by reacting an aluminum chelating agent and a silsesquioxane-type oxetane derivative in the presence of an alicyclic epoxy compound in a non-aqueous solvent by heating, and then further reacting the resultant mixture with a liquid epoxy resin and an imidazole compound or with a divinylbenzene and a radical polymerization initiator.

As the non-aqueous solvent, lower alkyl acetates, such as ethyl acetate and the like, and aromatic solvents, such as toluene and the like, can be preferably used. The heating temperature depends on the kind of solvent and the like, but is usually in the range of from 50 to 200° C., and preferably in the range of from 80 to 200° C. The heating time is usually in the range of from 1 to 3 hours, and preferably in the range of from 1 to 2 hours. The used amount of the non-aqueous solvent can be appropriately selected in consideration of the solubility of the other components and the like. Furthermore, if oxygen is present in the reaction atmosphere, there is a risk of the aluminum chelating agent being deactivated through oxidation. Thus, it is preferable to carry out the reaction in an inert gas atmosphere, for example a nitrogen atmosphere.

The aluminum chelate-based latent curing agent according to the present invention can be obtained by cooling the reaction solution, then filtering the produced sediment, washing the sediment with a poor solvent such as hexane, and drying under reduced pressure. In this case, among the sediment after the reaction has finished, it is preferable to obtain as the aluminum chelate-based latent curing agent which has passed through a filter having a predetermined pore size, for example, a filter made from Teflon (registered trademark) which has a pore size of 8 μm.

The thus-obtained aluminum chelate-based latent curing agent according to the present invention is obtained as microparticles having a primary particle size in the reaction system of from 0.5 to 10 μm by stirring the reaction system using a homogenizer (for example, IKA). However, when removed from the reaction system, the particles tend to turn into secondary particles having a size of from 0.5 to 100 μm. If an anisotropic conductive adhesion coating solution using a relatively large aluminum chelate-based latent curing agent agglomerated in this manner is coated on a substrate, the aluminum chelate-based latent curing agent may become caught in the coating outlet of the coater. In some cases linear patterns (coating stripes) where the coating solution has not been fully coated may form. The occurrence of such coating stripes is an obstacle to realizing a reliable anisotropic conductive connection. Therefore, for relatively large-sized agglomerated secondary particles of the aluminum chelate-based latent curing agent, an operation to pulverize to primary particles is necessary. After the pulverizing is finished, as described above, it is preferable to pass the pulverized matter through a filter having a predetermined pore size.

When pulverizing, a hammer mill, a turbo mill, a roll mill, a jet mill and the like can be used.

According to the above-described production method of the present invention, the curing properties of the aluminum chelate-based latent curing agent can be controlled by varying the kind and used amount of the silsesquioxane-type oxetane derivative and alicyclic epoxy compound, the kind and used amount of the aluminum chelating agent, reaction conditions and the like. For example, if the reaction temperature is lowered, the curing temperature can be lowered, while conversely, if the reaction temperature is increased, the curing temperature can be increased.

The aluminum chelate-based latent curing agent according to the present invention can be used for the same applications as conventional imidazole-based latent curing agents, and can preferably provide a low-temperature, rapid curing thermosetting composition by using together with a silane coupling agent and a thermosetting compound.

If the used amount of the aluminum chelate-based latent curing agent in the thermosetting composition is too small, the composition does not sufficiently cure, while if the used amount is too large, the resin properties (for example, flexibility) of the cured matter of the composition deteriorate. Thus, with respect to 100 parts by weight of the thermosetting compound, the used amount is preferably in the range of from 1 to 30 parts by weight, and more preferably in the range of from 1 to 20 parts by weight.

The silane coupling agent has a function of initiating cationic polymerization of a thermosetting resin (for example, a thermosetting epoxy resin) in conjunction with the aluminum chelating agent, as described in paragraphs 0010 to 0014 of Japanese Patent Application Laid-Open No. 2002-368047. Furthermore, it is thought that the silane coupling agent has a function of capping hydroxyl groups which are unstable and can become a catalyst poison, thereby stabilizing the reaction system. Such a silane coupling agent has 1 to 3 lower alkoxy groups in the molecule, and may have a group which is reactive to the functional group of the thermosetting resin in the molecule. Examples of such a group include a vinyl group, a styryl group, an acryloyloxy group, a methacryloyloxy group, an epoxy group, an amino group, a mercapto group and the like. Among them, an alicyclic epoxy-type silane coupling agent is especially preferred. Furthermore, since the aluminum chelate-based latent curing agent according to the present invention is a cationic curing agent, a silane coupling agent having an amino group or a mercapto group can be used in cases where the amino group or mercapto group essentially does not capture the produced cation species. In addition, it is preferred to use the alicyclic epoxy type silane coupling agent together with a silane coupling agent which contains an ethoxysilyl group. In such a case, a balance can be attained between exothermic onset temperature and the leading edge peak.

Specific examples of such a silane coupling agent include: vinyl tris(2-methoxyethoxy)silane, vinyl triethoxysilane, vinyl trimethoxysilane, 3-styryltrimethoxysilane, 3-methacryloxypropyltrimethoxysilane, 3-acryloxypropyltrimethoxysilane, 3-glycidoxypropyltrimethoxysilane, 3-glycidoxypropylmethyldiethoxysilane, N-2-(aminoethyl)-3-aminopropyltrimethoxysilane, N-2-(aminoethyl)-3-aminopropylmethyldimethoxysilane, 3-aminopropyltriethoxysilane, N-phenyl-3-aminopropyltrimethoxysilane, 3-mercaptopropyltrimethoxysilane, 3-chloropropyltrimethoxysilane, 3-glycidoxypropyltriethoxysilane and the like. Preferred examples of an alicyclic epoxy type silane coupling agent include the 2-(3,4-epoxycyclohexyl)ethyltrimethoxysilane represented by the formula (3).

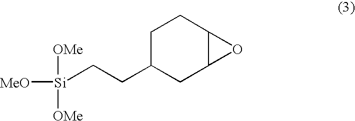

If the used amount of the silane coupling agent in the thermosetting composition is too small, the composition has low curing properties, while if the used amount is too large, the resin properties (for example, storage stability) of the cured matter of the composition deteriorate. Thus, with regard to 100 parts by weight of the aluminum chelate-based latent curing agent, the content is preferably in the range of from 1 to 1000 parts by weight, and more preferably in the range of from 50 to 500 parts by weight.

Examples of thermosetting compounds which can be used include thermosetting epoxy resins or compounds, thermosetting urea resins, thermosetting melamine resins, thermosetting phenol resins, oxetane compounds and the like. Among these, if adhesive strength after curing is considered as a beneficial point, thermosetting epoxy resins or compounds can be preferably used.

Such thermosetting epoxy resins or compounds may be in a liquid or a solid state, and preferably have an epoxy equivalent of usually about 100 to 4,000, and two or more epoxy groups in the molecule. Examples which can be preferably used include bisphenol A-type epoxy resins, phenol novolac-type epoxy resins, cresol novolac-type epoxy resins, ester-type epoxy compounds, alicyclic epoxy compounds and the like. In addition to these, monomers and oligomers are included in these compounds. Among these, from the standpoint of high reactivity, alicyclic epoxy compounds, such as CEL2021P (manufactured by Daicel Chemical Industries Ltd.), can be preferably used.

The oxetane compounds may be in a liquid or a solid state, and preferably have two or more oxetanyl groups in the molecule. Examples which can be preferably used include OXT-121, OXT-221 and OX-SQ-H (manufactured by Toagosei Co., Ltd.). In addition, monomers and oligomers are included in these compounds. Among these, from the standpoint of low reactivity and ionic impurity concentration, OXT-221, OX-SQ-H and the like can be preferably used.

The thermosetting composition according to the present invention can be produced by uniformly mixing and stirring by an ordinary method the aluminum chelate-based latent curing agent, the silane coupling agent, the thermosetting compound and other additives which may be added as required.

The thus-obtained thermosetting composition according to the present invention has a latent aluminum chelate-based curing agent, so that despite being a one-pack type, the composition has excellent storage stability. Furthermore, the aluminum chelate-based latent curing agent works together with the silane coupling agent so that the thermosetting compound can undergo low-temperature, rapid cationic polymerization.

Moreover, by further blending conductive particles, such as nickel particles, known in the art for anisotropic conductive connection, or a deposited film known in the art, such as a phenoxy resin, in the thermosetting composition according to the present invention, the thermosetting composition can be used as an anisotropic conductive composition. If the thermosetting composition is molded into a film, it can be used as an anisotropic conductive film. The kind, particle size and blended amount of the conductive particles, and kind, blended amount and film thickness of the deposited film can be made to have the same structure as known anisotropic conductive pastes or anisotropic conductive films. A representative blend example of the anisotropic conductive paste or film has 8 to 12 parts by weight of aluminum chelate-based latent curing agent, 50 to 80 parts by weight of phenoxy resin, 20 to 50 parts by weight of alicyclic epoxy compound, 5 to 30 parts by weight of epoxy-modified polyolefin, 1 to 20 parts by weight of silane coupling agent and 1 to 20 parts by weight of conductive particles. In addition, a solvent, a monomer for dilution and the like may be appropriately blended as required. Such an anisotropic conductive paste or anisotropic conductive film enables low-temperature, quick connection in about 5 seconds at 150° C., also with low conduction resistance and good adhesion strength.

### EXAMPLES

The present invention will now be described in more detail by the following examples.

### Example 1

A three-necked flask made from Teflon (registered trademark) equipped with a condenser tube was charged with 177.3 g of kerosene, 9.1 g of 66% solution of an aluminum chelating agent (aluminum ethylacetoacetate diisopropylate; ALCH, manufactured by Kawaken Fine Chemicals Co., Ltd.) in toluene, 9.4 g of 66% solution of a silsesquioxane-type oxetane derivative (OX-SQ-H, Toagosei Co., Ltd.) in toluene, and 4.2 g of 66% solution of an alicyclic epoxy compound (3′,4′-epoxycyclohexylmethyl 3,4-epoxycyclohexanecarboxylate; CEL2021P, Daicel Chemical Industries Ltd.) in toluene, and the resultant mixture was stirred for 30 minutes at 140° C. by a homogenizer (13,500 rpm). Next, 6.2 g of 66% solution of bisphenol A-type liquid epoxy resin (YL980, Japan Epoxy Resins Co., Ltd.) in toluene and 0.6 g of 66% solution of 2-ethyl-4-methylimidazole (2E4MZ, Shikoku Chemicals Corporation) in toluene were mixed, and the resultant mixture was immediately added dropwise to the reaction mixture. The resultant mixture was stirred for a further 30 minutes at 140° C. by a homogenizer (13,500 rpm). After the stirring was finished, the reaction mixture was cooled to room temperature using an ice bath, and the mixture was then filtered using a Buchner funnel. The obtained powder was washed 3 times using 100 g of heptane, then dried under reduced pressure to obtain a pale yellow powder in a 67% yield as an aluminum chelate-based latent curing agent.

### Example 2

A pale yellow powder was obtained in a 58% yield as an aluminum chelate-based latent curing agent by repeating the same procedure of Example 1, except that the amount of 66% solution of bisphenol A-type liquid epoxy resin (YL980, Japan Epoxy Resins Co., Ltd.) in toluene was changed from 6.2 g to 3.1 g, and the amount of 66% solution of 2-ethyl-4-methylimidazole (2E4MZ, Shikoku Chemicals Corporation) in toluene was changed from 0.6 g to 0.3 g.

### Example 3

A pale yellow powder was obtained in a 62% yield as an aluminum chelate-based latent curing agent by repeating the same procedure of Example 1, except that the amount of 66% solution of 2-ethyl-4-methylimidazole (2E4MZ, Shikoku Chemicals Corporation) in toluene was changed from 0.6 g to 0.12 g.

### Example 4

A pale yellow powder was obtained in a 52% yield as an aluminum chelate-based latent curing agent by repeating the same procedure of Example 1, except that the amount of 66% solution of 2-ethyl-4-methylimidazole (2E4MZ, Shikoku Chemicals Corporation) in toluene was changed from 0.6 g to 0.25 g.

### Example 5

A three-necked flask made from Teflon (registered trademark) equipped with a condenser tube was charged with 177.3 g of kerosene, 9.1 g of 66% solution of an aluminum chelating agent (aluminum ethylacetoacetate diisopropylate; ALCH, manufactured by Kawaken Fine Chemicals Co., Ltd.) in toluene, 9.4 g of 66% solution of a silsesquioxane-type oxetane derivative (OX-SQ-H, Toagosei Co., Ltd.) in toluene, and 4.2 g of 66% solution of an alicyclic epoxy compound (3′,4′-epoxycyclohexylmethyl 3,4-epoxycyclohexanecarboxylate; CEL2021P, Daicel Chemical Industries Ltd.) in toluene, and the resultant mixture was stirred for 30 minutes at 140° C. by a homogenizer (13,500 rpm). Next, a mixed solution of 7.2 g of 66% solution of styrene (Kanto Chemical Co., Inc.) in toluene, 0.8 g of 66% solution of divinylbenzene (Merck Ltd.) in toluene, and 0.32 g (6 wt % with respect to the monomer) of a radical polymerization initiator (Peroyl L, NOF Corporation) was added dropwise to the reaction mixture. The resultant mixture was stirred for a further 30 minutes at 140° C. by a homogenizer (13,500 rpm). After the stirring was finished, the reaction mixture was cooled to room temperature using an ice bath, and the mixture was then filtered using a Buchner funnel. The obtained powder was washed 3 times using 100 g of heptane, then dried under reduced pressure to obtain a white powder in a 41% yield (8.4 g) as an aluminum chelate-based latent curing agent.

### Example 6

A white powder was obtained in a 38% (8.0 g) yield as an aluminum chelate-based latent curing agent by repeating the same procedure of Example 5, except that the used amount of the radical polymerization initiator (Peroyl L, NOF Corporation) was changed from 0.35 g to 0.53 g.

### Comparative Example 1

A three-necked flask made from Teflon (registered trademark) equipped with a condenser tube was charged with 177.3 g of kerosene, 9.1 g of 66% solution of an aluminum chelating agent (aluminum ethylacetoacetate diisopropylate; ALCH, manufactured by Kawaken Fine Chemicals Co., Ltd.) in toluene, 9.4 g of 66% solution of a silsesquioxane-type oxetane derivative (OX-SQ-H, Toagosei Co., Ltd.) in toluene, and 4.2 g of 66% solution of an alicyclic epoxy compound (3′,4′-epoxycyclohexylmethyl 3,4-epoxycyclohexanecarboxylate; CEL2021P, Daicel Chemical Industries Ltd.) in toluene, and the resultant mixture was stirred for 1 hour at 140° C. by a homogenizer (13,500 rpm). After the stirring was finished, the reaction mixture was cooled to room temperature using an ice bath, and the mixture was then filtered using a Buchner funnel. The obtained powder was washed 3 times using 100 g of heptane, then dried under reduced pressure to obtain a pale yellow powder in a 55% yield as an aluminum chelate-based latent curing agent.

### Comparative Example 2

A white powder was obtained in a 57% yield as an aluminum chelate-based latent curing agent by repeating the same procedure of Example 1, except that 2-ethyl-4-methylimidazole was not used.

### Comparative Example 3

When the same procedure of Example 5 was repeated except for not using the radical polymerization initiator, a powder of an aluminum chelate-based latent curing agent was not obtained.

### Comparative Example 4

A three-necked flask made from Teflon (registered trademark) equipped with a condenser tube was charged with 177.3 g of kerosene, 9.1 g of 66% solution of an aluminum chelating agent (aluminum ethylacetoacetate diisopropylate; ALCH, manufactured by Kawaken Fine Chemicals Co., Ltd.) in toluene, 9.4 g of 66% solution of a silsesquioxane-type oxetane derivative (OX-SQ-H, Toagosei Co., Ltd.) in toluene, and 4.2 g of 66% solution of an alicyclic epoxy compound (3′,4′-epoxycyclohexylmethyl 3,4-epoxycyclohexanecarboxylate; CEL2021P, Daicel Chemical Industries Ltd.) in toluene, and the resultant mixture was stirred for 30 minutes at 140° C. by a homogenizer (13,500 rpm). Next, 4.0 g of an isocyanate compound (Coronate L45ET, Nippon Polyurethane Industry Co., Ltd.) was charged into the reaction mixture, and the resultant mixture was stirred for a further 30 minutes at 140° C. by a homogenizer (13,500 rpm). After the stirring was finished, the reaction mixture was cooled to room temperature using an ice bath, and the mixture was then filtered using a Buchner funnel. The obtained powder was washed 3 times using 100 g of heptane, then dried under reduced pressure to obtain 10.5 g of a pale yellow powder (synthesis yield of 62%) as an aluminum chelate-based latent curing agent. Then, 9.4 g of the obtained aluminum chelate-based latent curing agent was dispersed in heptane, and the resultant mixture was filtered with a filter having a pore size of 8 μm. The filtrate was dried to obtain 4.4 g (yield 47%) of a fine powder of an aluminum chelate-based latent curing agent.

### Evaluation Test 1

A thermosetting composition was prepared by uniformly mixing using a stirrer 0.2 g of the aluminum chelate-based latent curing agent obtained in Examples 1 to 6 and Comparative Example 1 to 4, 3.3 g of a matrix (oxetane derivative (DOX, Toagosei Co., Ltd.) or bis A-type liquid epoxy compound (YL980, Japan Epoxy Resins Co., Ltd.), or alicyclic epoxy compound (CEL2021P, Daicel Chemical Industries Ltd.)), and 0.8 g of a silane coupling agent (KBE403:KBM303=1:1). The resultant composition was subjected to thermal analysis using a differential thermal analysis (DSC) apparatus (DSC-60, Shimadzu Corporation) to measure the exothermic onset temperature (° C.), the exothermic peak temperature (° C.) and the gross calorific value (J/g). The obtained results are shown in Table 1. Furthermore, in terms of practical use, the preferred ranges for the exothermic onset temperature, the exothermic peak temperature and the gross calorific value are from 50 to 110° C., from 90 to 160° C. and 250 J/g or more, respectively.

TABLE 1

| | | Exothermic | Exothermic | |
|---|---|---|---|---|
| | | onset | peak | Gross |
| Latent curing | | temperature | temperature | calorific |
| agent | Matrix | (° C.) | (° C.) | value (J/g) |
| Example 1 | DOX | 106.3 | 156.0 | 125.5 |
| | YL980 | 80.4 | 118.8 | 29.0 |
| | CEL2021P | 73.9 | 94.5 | 128.6 |
| Example 2 | DOX | 84.9 | 105.5 | 145.9 |
| | YL980 | 78.9 | 100.9 | 42.6 |
| | CEL2021P | 71.3 | 99.0 | 337.5 |
| Example 3 | DOX | 94.3 | 114.1, 123.6 | 275.0 |
| | YL980 | 82.8 | 108.7 | 36.7 |
| | CEL2021P | 57.3 | 100.3, 131.3 | 522.0 |
| Example 4 | DOX | 97.7 | 121.7, 162.1 | 84.8 |
| | YL980 | 97.1 | 122.0 | 28.5 |
| | CEL2021P | 52.7 | 95.2, 128.3 | 433.2 |
| Example 5 | DOX | 74.4 | 120.8 | 387.1 |
| | YL980 | 85.7 | 116.7 | 35.8 |
| | CEL2021P | 55.4 | 90.7 | 497.3 |
| Example 6 | DOX | 84.3 | 112.0 | 380.5 |
| | YL980 | 87.8 | 124.7 | 32.5 |
| | CEL2021P | 66.8 | 94.6 | 600.4 |
| Comparative | DOX | 61.9 | 104.7 | 528.7 |
| Example 1 | YL980 | 86.1 | 122.6 | 29.5 |
| | CEL2021P | 66.4 | 100.2 | 637.6 |
| Comparative | DOX | 76.8 | 106.6 | 412.6 |
| Example 2 | YL980 | 74.4 | 103.3 | 40.6 |
| | CEL2021P | 60.3 | 96.8, 124.7 | 582.0 |
| Comparative | DOX | — | — | — |
| Example 3 | YL980 | — | — | — |
| | CEL2021P | — | — | — |
| Comparative | DOX | 81.2 | 110.1, 164.9 | 240.2 |
| Example 4 | YL980 | 92.0 | 123.0 | 31.3 |
| | CEL2021P | 52.5 | 91.9, 135.1 | 350.2 |

### Evaluation Test 2

A thermosetting composition was prepared by uniformly mixing using a stirrer 0.8 g of the aluminum chelate-based latent curing agent obtained in the above Examples 1 to 6 and Comparative Examples 1 to 4, 13.2 g of an oxetane derivative (DOX, Toagosei Co., Ltd.), and 3.2 g of a silane coupling agent (KBE403:KBM303=1:1) in the same manner as in the evaluation test 2. Four grams of the resultant composition was placed in a sample bottle, and then 1 g of the solvent shown in Table 2 was further added thereto. After confirming that the mixture was uniform, the sample bottle was placed in a 40° C. oven, and then it was confirmed every hour whether fluidity had been lost or not. Curing was determined as the point where fluidity was lost. The time required for curing is shown in Table 2.

TABLE 2

| Latent curing | | Ethyl acetate | Methyl ethyl | |
|---|---|---|---|---|
| agent | Toluene (hr) | (hr) | ketone (hr) | PGMAC (hr) |
| Example 1 | 50 | 16 | 50 | 50 |
| Example 2 | 16 | 16 | 16 | 16 |
| Example 3 | 22 | 22 | 22 | 22 |
| Example 4 | 22 | 11 | 22 | 22 |
| Example 5 | >13 | >13 | >13 | 13> |
| Example 6 | >23 | >23 | >23 | >23 |
| Comparative | <13 | <13 | <13 | <13 |
| Example 1 | | | | |
| Comparative | <11 | <11 | <11 | <11 |
| Example 2 | | | | |
| Comparative | — | — | — | — |
| Example 3 | | | | |
| Comparative | 60 | 60 | 60 | 60 |
| Example 4 | | | | |

From the results of Tables 1 and 2, it can be seen that good solvent resistance and good DSC measurement results were exhibited for the cases of Examples 1 to 6, in which by latter addition either a liquid epoxy resin and an imidazole compound were reacted, or an aromatic vinyl compound and a radical polymerization initiator were reacted. In contrast, in the case of Comparative Example 1, in which a polymer shell was not formed by latter addition, and in the case of Comparative Example 2, in which although a liquid epoxy resin was used, the liquid epoxy resin was not reacted with an imidazole compound, the overall solvent resistance was insufficient. In the case of Comparative Example 3, in which although an aromatic vinyl compound was used, the aromatic vinyl compound was not reacted with a radical polymerization initiator, since the aluminum chelate-based latent curing agent itself could not be obtained, evaluation could not be carried out. Furthermore, in the case of Comparative Example 4, in which a polymer shell was formed from an alicyclic epoxy compound and an outer shell was formed from an isocyanate compound, the tailing in DSC measurement was not large. Although solvent resistance increased, the reactivity of the aluminum chelate-based latent curing agent itself decreased.

### INDUSTRIAL APPLICABILITY

The aluminum chelate-based latent curing agent according to the present invention can cure a thermosetting composition at a relatively low temperature in a short time, and is thus useful as an adhesion material for electronic materials capable of low-temperature, rapid curing.

1. An aluminum chelate-based latent curing agent being made latent by reacting a silsesquioxane-type oxetane derivative with an aluminum chelating agent in the presence of an alicyclic epoxy compound, and then further reacting the resultant mixture with a liquid epoxy resin and an imidazole compound or with an aromatic vinyl compound and a radical polymerization initiator.

2. The aluminum chelate-based latent curing agent according to claim 1, wherein the aluminum chelating agent is a complex compound having three β-ketoenolate negative ions coordinated to aluminum.

3. The aluminum chelate-based latent curing agent according to claim 1, wherein the aluminum chelating agent is aluminum ethylacetoacetate diisopropylate, aluminum trisethylacetoacetate, aluminum alkylacetoacetate diisopropylate, aluminum bisethylacetoacetate monoacetylacetonate or aluminum trisacetylacetonate.

4. The aluminum chelate-based latent curing agent according to claim 1, wherein the aluminum chelating agent is aluminum ethylacetoacetate diisopropylate.

5. The aluminum chelate-based latent curing agent according to claim 1, wherein the silsesquioxane-type oxetane derivative contains an oxetanylsilsesquioxane represented by the formula (1).

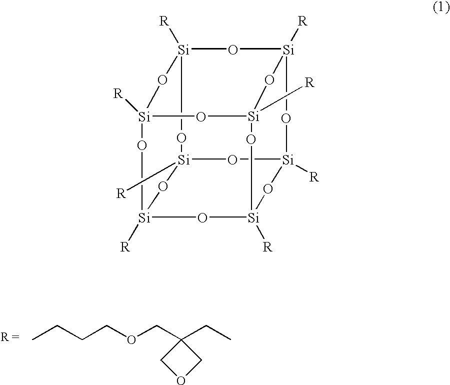

6. The aluminum chelate-based latent curing agent according to claim 1, wherein the alicyclic epoxy compound is 3′,4′-epoxycyclohexylmethyl 3,4-epoxycyclohexanecarboxylate.

7. The aluminum chelate-based latent curing agent according to claim 1, wherein the silsesquioxane-type oxetane derivative is contained in an amount of from 0.1 to 500 parts by weight with respect to 100 parts by weight of the aluminum chelating agent, and the alicyclic epoxy compound is contained in an amount of from 0.1 to 1,000 parts by weight with respect to 100 parts by weight of the sum of the aluminum chelating agent and the silsesquioxane-type oxetane derivative.

8. The aluminum chelate-based latent curing agent according to claim 1, wherein the liquid epoxy resin is contained in an amount of from 0.1 to 200 parts by weight with respect to 1 part by weight of the aluminum chelating agent, and the imidazole compound is contained in an amount of from 0.01 to 1 part by weight with respect to 1 part by weight of the liquid epoxy resin.

9. The aluminum chelate-based latent curing agent according to claim 1, wherein the aromatic vinyl compound is contained in an amount of from 0.1 to 200 parts by weight with respect to 1 part by weight of the aluminum chelating agent, and the radical polymerization initiator is contained in an amount of from 0.01 to 1 part by weight with respect to 1 part by weight of the aromatic vinyl compound.

10. A method for producing an aluminum chelate-based latent curing agent, the method comprising:
reacting an aluminum chelating agent and a silsesquioxane-type oxetane derivative in the presence of an alicyclic epoxy compound in a non-aqueous solvent by heating; and
further reacting the resultant mixture with a liquid epoxy resin and an imidazole compound or with an aromatic vinyl compound and a radical polymerization initiator to obtain the aluminum chelate-based latent curing agent as a sediment.

11. The production method according to claim 10, wherein a heating temperature is in the range of from 80 to 200° C.

12. The production method according to claim 10, wherein the reaction is carried out under a nitrogen atmosphere.

13. A thermosetting composition comprising the aluminum chelate-based latent curing agent according to claim 1, a silane coupling agent and a thermosetting compound.

14. The thermosetting composition according to claim 13, wherein the thermosetting compound is an alicyclic epoxy compound.

15. The thermosetting composition according to claim 13, wherein the thermosetting compound is an oxetane compound.

16. The thermosetting composition according to claim 13, wherein the silane coupling agent is an oxetane-type silane coupling agent and/or an alicyclic epoxy-type silane coupling agent.

17. The thermosetting composition according to claim 16, wherein the oxetane-type silane coupling agent is an oxetanyl silane compound represented by the formula (2).

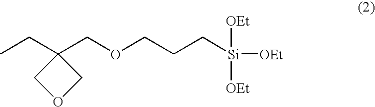

18. The thermosetting composition according to claim 16, wherein the alicyclic epoxy-type silane coupling agent is 2-(3,4-epoxycyclohexyl)ethyltrimethoxysilane represented by the formula (3).

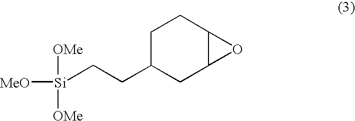

19. An anisotropic conductive composition comprising conductive particles dispersed in the thermosetting composition according to claim 13.
